(19) United States
(12) Patent Application Publication
(10) Pub. No.: US 2010/0224480 A1
(43) Pub. Date: Sep. 9, 2010

(54) Method for Photocatalytic Separation from Surfactant-Containing Dispersions

(76) Inventors: Stephan Bloess, Burscheid (DE); Lothar Elfenthal, Langenfeld (DE); Karsten Loehr, Ulm (DE)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 12/706,767

(22) Filed: Feb. 17, 2010

(30) Foreign Application Priority Data
Mar. 3, 2009 (DE) DE 102009011117.4

(51) Int. Cl. C08F 6/12; C08L 27/18

(52) U.S. Cl. 204/158.21; 204/158.2; 524/805

(57) ABSTRACT

The invention relates to a method for photocatalytic separation of a dispersed substance from a surfactant-containing dispersion. The surfactant-containing dispersion contains at least one dispersant, one dispersed substance, one surfactant and one photocatalyst. Irradiation of the photocalyst causes the decomposition or modification of the surfactant allowing for the separation of the dispersed substance from the dispersant.

### RELATED APPLICATION

This application claims the benefit of DE 10 2009 011 117.4 field Mar. 3, 2009.

### TECHNICAL FIELD OF THE INVENTION

The invention relates to a method for separation from surfactant-containing dispersions by means of photocatalysis, as well as to a correspondingly composed dispersion.

### BACKGROUND OF THE INVENTION

Dispersions are heterogeneous mixtures of at least two different substances, the dispersed substance and the dispersant, which are mixed together. Here, “surfactant-containing dispersion” is intended to mean a heterogeneous mixture that additionally contains a surfactant.

In the context of dispersions, a distinction is made—depending on the state of aggregation of the substances involved—between suspensions (a solid dispersed substance in a liquid dispersant), emulsions (a liquid dispersed substance in a liquid dispersant) and foams (a gaseous dispersed substance in a liquid dispersant). There are also dispersions with a solid dispersant (solids mixtures) or a gaseous dispersant (aerosols), but these generally mix without auxiliary surfactants.

Surfactants are active substances that mediate between different surface properties, thereby supporting the formation of mixtures of heterogeneous substances. Regarding the surface properties, a fundamental distinction is made between polar (hydrophilic) substances and non-polar (hydrophobic) substances. The individual molecules of a surfactant have a polar end and a non-polar end, thus mediating between these different properties by aligning themselves in an intermediate molecular layer. Furthermore, a specific surface tension exists for every substance, expressing the molecular bonding forces per unit area. Here, too, surfactants can mediate between different substances as a result of a respectively matching surface tension.

Depending on the type of dispersion, surfactants are also referred to as “wetting agents” in suspensions, as “emulsifiers” in emulsions and as “foaming agents” in foams. As a rule, surfactants consist of longer-chain, carbon-containing molecules. Depending on the nature of the hydrophilic terminal group of the surfactant molecule, a distinction is made between anionic surfactants (with a negatively charged terminal group), cationic surfactants (with a positively charged terminal group), non-ionic surfactants (with an uncharged terminal group) and amphoteric surfactants (with a dipolar terminal group). This hydrophilic terminal group is connected to the respective hydrophobic terminal group via a chain of hydrocarbons.

Photocatalysts are semiconductors in which the electromagnetic radiation of light in the visible or invisible spectrum leads to an electronically excited state. The excited electrons are in turn the cause of a chemical reaction on the surface of the photocatalyst. The resultant photocatalytic reaction is used, for example, in photography, in the purification of waste water and air, or in energy conversion by photosynthesis, in photovoltaics or in photolysis.

The separation of dispersions means a method of substance separation where the segregation of the substances involved leads to deposition of the dispersed substances. This kind of substance separation can be caused by exposure to mechanical forces, for example. Thus, gravity or centrifugal force leads to sedimentation of the dispersed substances. When exposed to mechanical forces, dispersed substance particles are also separated as a result of their size, e.g. by means of screens, filters or membranes, or as a result of their mobility, e.g. by means of fluidised beds and classifiers. Furthermore, the force effect of electric or magnetic fields can be used to separate dispersed substances, e.g. by electrolysis, magnetic or eddy-current separation. Methods of chemical substance separation include, for example, precipitation, extraction or distillation, where either the dispersed substance or the dispersant is removed from the mixture.

The separation of dispersed substances from surfactant-containing dispersions can additionally be achieved by a reaction with the surfactant, during which the surfactant is decomposed or at least loses its mixing function. For example, a further substance can be added that binds the surfactant more strongly than the dispersed substance, as a result of which the latter is segregated and separated. The surfactant can also be modified or decomposed by an added reagent or by a thermal reaction, such that the dispersed substance is segregated and separated. However, care must be taken in each case to ensure that the added substances and the reactions do not also change the properties of the separated substances.

For example, the aqueous dispersion Teflon PTFE 30B from DuPont is used to make textile or porous substrates hydrophobic and thus keep them dry. To this end, the substrate is coated with the dispersion, and the dispersed particles are subsequently separated from the dispersion. According to the manufacturer's information, this is done by evaporation of the water used as the dispersant at roughly 120° C. and subsequent thermal decomposition of the surfactant at roughly 290° C. This greatly restricts use of the dispersion on temperature-sensitive substrates. Moreover, some applications require better deactivation of the surfactant, this only taking place at above 360° C. However, the dispersed Teflon particles also already begin to decompose at this temperature. Therefore, despite elaborate process and temperature control, this separation entails a number of restrictions as regards waterproofing.

### SUMMARY OF THE INVENTION

The object of the invention is to indicate a method for separation of a dispersed substance from a surfactant-containing dispersion that overcomes the disadvantages of the prior art.

The object is solved by a method for separation of a dispersed substance from a surfactant-containing dispersion by decomposition of the surfactant, wherein the dispersion comprises at least one dispersant, at least one dispersed substance, at least one surfactant and at least one photocatalyst and wherein the surfactant is decomposed photocatalytically due to irradiation with electromagnetic waves or photons.

The object is further solved by a photocatalytically separable dispersion comprising at least one dispersant, at least one dispersed substance, at least one surfactant and at least one photocatalyst, whereby the dispersed substance is polytetratluoroethylene (PTFE) or latex.

### DESCRIPTION OF THE PREFERRED EMBODIMENTS

A photocatalytically separable dispersion is characterised in that it contains several functional mixture components. In this context, a mixture component can in turn itself consist of one or more substances having the same function. The individual functional mixture components are as follows:

a dispersed substance,

a surfactant,

a dispersant, and

a photocatalyst.

The method for separating the photocatalytically separable dispersion is based on technical irradiation with suitable photons. It is known that photocatalysts lead to chemical reactions when irradiated with suitable photons. According to the invention, this process decomposes the surfactant. In this context “decomposition” of the surfactant is understood to include also a modification to such an extent that the surfactant effect is eliminated. This, in turn, has the consequence that the dispersed substance is separated from the dispersion.

In one embodiment of the invention, the photocatalyst is an active substance based on titanium dioxide. It is known that, when the anatase and rutile modifications of the semiconductor titanium dioxide are irradiated with ultraviolet “UV” light, electron-hole pairs are formed that migrate to the surface, where they produce highly reactive radicals. In addition, titanium dioxide can be modified in such a way that the photocatalytic effect also occurs on exposure to visible light in the spectral wavelength range from roughly 400 to 700 nm. This modification is, for example, performed by doping the semiconductor with metal ions, such as chromium, iron or manganese, or with nitrogen, sulphur or carbon, or mixtures thereof. According to the invention, this causes the surfactant to be radically decomposed, or modified to such an extent that the surfactant effect is eliminated. This, in turn, has the consequence that the dispersed substance is separated from the dispersion.

In a further embodiment of the invention, the dispersant used is water or an aqueous liquid. It is known that, when excited with photons from UV light or visible light or mixtures thereof in an aqueous environment, photocatalysts based on titanium dioxide lead to the formation of hydroxyl radicals. In turn, these hydroxyl radicals react intensively with other constituents of the environment. According to the invention, the hydroxyl radicals then decompose the surfactant, or modify it to such an extent that the surfactant effect is eliminated. This, in turn, has the consequence that the dispersed substance is separated from the dispersion.

PTFE (polytetrafluoroethylene) or latex is particularly suitable as the dispersed substance. Experience has shown that, in principle, the suitable surfactants include all surfactants that support the formation of a mixture of the respective dispersed substance and the respective dispersant. Perfluorinated surfactants are particularly suitable.

### Example

The invention is explained in more detail on the basis of the following example, although this is not intended to restrict the invention in any way.

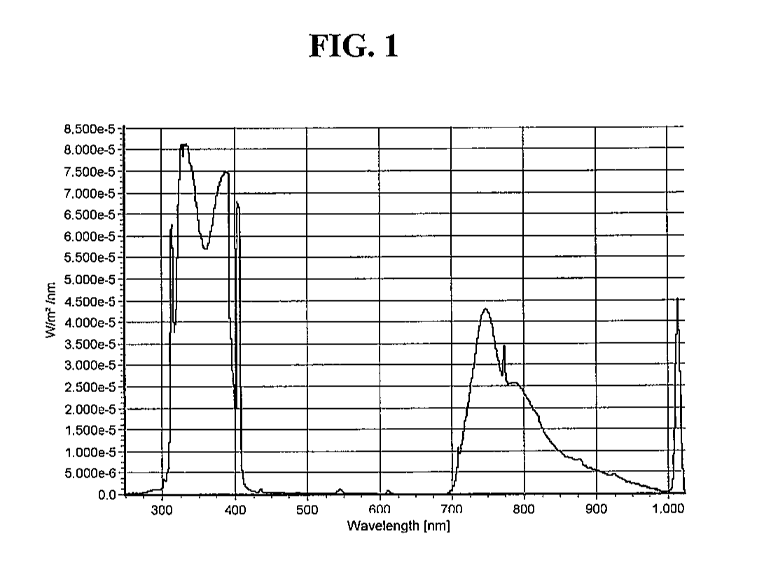

300 mg of the commercial titanium dioxide photocatalyst KRONOS vip 7000 are dispersed, for 1 minute at 9,500 rpm using an Ultra-Turrax, in 100 ml of a 0.0039 mole % commercial Triton X-102 solution (octylphenol ethoxylate) from DOW, containing 39 ppm Triton X-102, corresponding to a total organic carbon (TOG) content of 26 ppm. The suspension prepared in this way is subsequently irradiated by a UV lamp (spectrum is depicted in FIG. 1) from a distance of 8 cm for periods of 0, 150, 300 and 450 minutes. Following the respective irradiation, the total organic carbon content of the suspension is determined. In addition, the Triton X content of the respective suspension is determined on the basis of the characteristic bands at 223 nm and 274 nm in the UV absorption spectrum (Table 1).

Table 1 shows that both the total organic carbon content and the Triton X content decline with increasing exposure duration.

At the same time, a Triton X-102 solution is prepared in the same way, but without titanium dioxide photocatalyst, and subsequently irradiated by a UV lamp in the same way. Following the respective irradiation, the total organic carbon content and the Triton X content of the respective solution are determined on the basis of the characteristic bands at 223 nm and 274 nm in the UV absorption spectrum (Table 2).

Table 2 shows that, without titanium dioxide photocatalyst, neither the total organic carbon content, nor the Triton X content declines with increasing exposure duration.

TABLE 1
Decomposition of Triton X-102 in the presence of KRONOS vlp 7000
when exposed to UV light

| | | 223 nm | 274 nm |
|---|---|---|---|
| min | ppm TOC | ppm Triton X-102 | ppm Triton X-102 |
| 0 | 26 | 39 | 39 |
| 150 | 22 | 33 | 39 |
| 300 | 11 | 9 | 18 |
| 450 | 2 | 3 | 8 |

TABLE 2
No decomposition of Triton X-102 when exposed to UV light
(without KRONOS vlp 7000)

| | | 223 nm | 274 nm |
|---|---|---|---|
| min | ppm TOC | ppm Triton X-102 | ppm Triton X-102 |
| 0 | 25 | 40 | 45 |
| 150 | 25 | 39 | 46 |
| 300 | 25 | 39 | 45 |
| 450 | 25 | 40 | 46 |

The above description of certain embodiments are made for purposes of illustration only and are not intended to be limiting in any manner. Other alterations and modifications of the preferred embodiments will become apparent to those of ordinary skill in the art upon reading this disclosure, and it is intended that the scope of the invention disclosed herein be limited only by the broadest interpretation of the appended claims to which the inventor is legally entitled.

1. A method for separation of a dispersed substance from a surfactant-containing dispersion by decomposition of the surfactant comprising:
providing a dispersion comprising at least one dispersant, at least one dispersed substance, at least one surfactant and at least one photocatalyst;
irradiating the dispersion with selected electromagnetic waves or photons; and
wherein the surfactant is decomposed photocatalytically.

2. The method of claim 1 wherein the dispersed substance is selected from the group consisting of polytetrafluoroethylene (PTFE) and latex.

3. The method of claim 2 wherein the dispersed substance is polytetrafluoroethylene (PTFE).

4. The method of claim 1 wherein the photocatalyst is TiO₂.

5. The method of claim 4 wherein the TiO₂ is doped.

6. The method of claim 5 wherein the TiO₂ is doped with a material selected from the group comprising: chromium, iron, maganese, nitrogen, sulphur, carbon, and mixtures thereof.

7. The method of claim 1 wherein the dispersant is an aqueous liquid.

8. The method of claim 1 wherein the selected electromagnetic waves or photons is selected from the group consisting of UV light, visible light and combinations thereof.

9. The method of claim 1 wherein the at least one dispersed substance is polytetrafluoroethylene (PTFE), the dispersant is water, the at least one photocatylyst is TiO₂, and the at least one surfactant is a perfluorinated surfactant.

10. A photocatalytically separable dispersion comprising:
at least one dispersant;
at least one dispersed substance;
at least one surfactant;
at least one photocatalyst;
wherein the at least one photocatalyst is adapted to cause the at least one surfactant to decompose when dispersion is irradiated with selected electromagnetic waves or photos; and
wherein the at least one dispersed substance is selected from the group consisting of polytetrafluoroethylene (PTFE) and latex.

11. The dispersion of claim 10 wherein the at least one dispersed substance is polytetrafluoroethylene (PTFE).

12. The dispersion of claim 10 wherein the photocatalyst is TiO₂.

13. The dispersion of claim 12 wherein the TiO₂ is doped.

14. The dispersion of claim 13 wherein the TiO₂ is doped with a material selected from the group comprising: chromium, iron, maganese, nitrogen, sulphur, carbon, and mixtures thereof.

15. The dispersion of claim 10 wherein the dispersant is an aqueous liquid.

16. The dispersion of claim 10 wherein the selected electromagnetic waves or photons is selected from the group consisting of UV light, visible light and combinations thereof.

17. The dispersion of claim 10 wherein the at least one dispersed substance is polytetrafluoroethylene (PTFE), the dispersant is water, the at least one photocatylyst is TiO₂, and the at least one surfactant is a perfluorinated surfactant.

18. The dispersion of claim 17 wherein the TiO₂ is doped with a material selected from the group comprising: chromium, iron, maganese, nitrogen, sulphur, carbon, and mixtures thereof.
